(19) United States
(12) Patent Application Publication
(10) Pub. No.: US 2006/0222296 A1
(43) Pub. Date: Oct. 5, 2006

(54) Optical wavelength division multiplexer

(75) Inventors: Kouichi Suzuki, Tokyo (JP); Tomoyuki Hino, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/392,932

(22) Filed: Mar. 30, 2006

(30) Foreign Application Priority Data
Mar. 31, 2005 (JP) 2005-105253

(51) Int. Cl. G02B 6/26

(52) U.S. Cl. 385/39

(57) ABSTRACT

In an optical wavelength division multiplexer, flattening of band characteristic can be realized while reducing excessive loss due to the flattening of band characteristic in an arrayed waveguide grating. Further, the flat band of the band characteristic can be made broader.

The optical wavelength division multiplexer according to the invention includes: a first coupler optical waveguide 104 and a second coupler optical waveguide 106; one or more input side connecting part waveguide(s) 103 with one end connected to an input optical waveguide 101 and the other end connected to an optical input end face of the first coupler optical waveguide 104; one or more output side connecting part waveguide(s) 103′ with one end connected to an output optical waveguide 107 and the other end connected to an optical output end face of the second coupler optical waveguide 106; and an arrayed optical waveguide 105 connected between the first coupler optical waveguide 104 and the second coupler optical waveguide 106 and having plural channel waveguides with different lengths from one another, and further includes an optical interferometer connected to at least two optical waveguides between the input side connecting part waveguide 103 and the input optical waveguide 101. The optical interferometer includes a ring structure 202 that feeds back an input light, and is provided so that an interference period of the optical interferometer may become equal to a difference between frequencies of light output from adjacent optical waveguides of the output side connecting part waveguide 107.

This application is based on Japanese Patent application NO. 2005-105253, the content of which is incorporated hereinto by reference.

### FIELD OF THE INVENTION

The present invention relates to an optical wavelength division multiplexer, and specifically to an optical wavelength division multiplexer of an arrayed waveguide grating.

### RELATED ART

With growing demand for communication, optical communication systems using DWDM (Dense Wavelength Division Multiplexing) are widely used in intercontinental and intercity large-capacity long-distance networks. The demand for waveguide type optical function devices such as AWG (Arrayed Waveguide Grating) devices as key components for the DWDM system is increasing. Since the arrayed waveguide grating can be fabricated in the same process and the same number of steps regardless of the number of channels and there is no characteristic degradation such as loss increase in principle, it is used as a key device for wavelength division multiplexing in the case where the number of channels becomes larger.

Further, the introduction of communication systems using new ROADM (Reconfigurable Optical Add/Drop Multiplexing) employing the DWDM technology for intercity communication application has recently started. As shown in FIG. 4, since the ROADM system enables existing optical fiber equipment to be efficiently utilized by introducing an arbitrary wavelength channel into another path, future rapid induction is expected.

Here, normally, the band characteristic of an AWG (Arrayed Waveguide Grating) has a Gaussian shape as shown in FIG. 1. When many Gaussian-shaped AWGs are cascade-connected, the multiplication of band characteristics (FIGS. 2A and 2B) are duplicated, and the combined band characteristic becomes narrow as shown in FIG. 2C and the transmission band can not be maintained. On this account, in the ROADM passing plural wavelength nodes, it is necessary to improve characteristics of optical filters. If it is possible to flatten the band characteristics of the optical filters as shown in FIGS. 3A and 3B, even when the AWGs are cascade-connected, the final band characteristic becomes flat as shown in FIG. 3C, and thereby, the broadband transmission characteristics can be maintained even via plural nodes.

Further, in the case where a quartz material is used as the AWG, the frequency of the transmitted light has a temperature coefficient that changes by about 0.01 nm/° C. relative to the temperature. Accordingly, a system of keeping the temperature of the optical device constant and fixing the transmission wavelength is adopted because variations in the transmission wavelength due to environmental temperature or the like cause degradation of transmission characteristics. However, in the system of controlling the chip temperature using a heater or the like to control the center wavelength, power supply is required and circuits for precise dynamic control are required to be incorporated and thereby, the requirements lead to cost increase.

Further, in an MUX/DMUX filter adaptable for the ROADM system, in the case where the effective band of channel spacing is narrow, the transmission wavelength of the filter and the emission wavelength of a light source vary by receiving the influences of variations in outside air temperature and the like. Furthermore, since the wavelength of each device in each node must be controlled so as not to largely shift from the defined value, the problem with temperature variations becomes more serious as the number of passing nodes is larger. Accordingly, the effective bandwidth of about 66% of channel spacing is required in the MUX/DMUX filter.

Therefore, in order to realize the flat band characteristic in the AWG, a method of adjusting the light intensity distribution of an output port is disclosed in Japanese Laid-open patent publication NO. 10-197735 (See Japanese Laid-open patent publication NO. 10-197735). However, there is a problem that excessive loss of about 2.0 dB in principle due to flattening occurs by the method.

In an AWG that realizes the flat band characteristic according to the conventional technology, a method of achieving top flattening of channel band by controlling light intensity at a coupler output end is used.

FIGS. 9A to 9F are relationship diagrams between light intensity patterns (FIGS. 9A to 9C) in the coupler coupling part at the input side in an AWG using a typical waveguide as the waveguide array at the output side and band characteristics (FIGS. 9D to 9E) of the AWG. FIG. 9D corresponds to FIG. 9A, FIG. 9E corresponds to FIG. 9B, and FIG. 9F corresponds to FIG. 9C.

It is seen that, in order to realize the flat band characteristic like the graph in FIG. 9E, it is necessary to realize the input side light intensity pattern as shown in FIG. 9B. That is, in order to realize the flat band characteristic, it is necessary that the central part of the light intensity in the coupler coupling part at the input side has a light intensity distribution with a recessed shape like the graph in FIG. 9B. This is because the band characteristic of the AWG is determined by the convolution of the light intensity distribution in the coupler connecting part at the input side and the light intensity distribution in the waveguide coupler connecting part at the opposite side. However, the AWG having such a light intensity distribution inevitably has excessive loss by the flattening. This is because the shapes of the recessed light intensity entering the output optical waveguide and the Gaussian light intensity of the output optical waveguide are not the same, and the excessive loss is typically near 2 dB. In the case of a normal Gaussian AWG, there is no excessive loss because completely the same light intensity shapes are combined. On this account, the insertion loss of the AWG that realizes flat band characteristic according to the conventional technology is about 2 dB larger than the Gaussian type, and generally the insertion loss is near 4 to 5 dB in a product.

To solve the problem of excessive loss, there is a technology of top flattening of band characteristic in an AWG using two cascade-connected interferometers (hereinafter, an interferometer used for top flattening of band characteristic in an AWG is referred to as a flattening interferometer)(see C. R. Doerr et al, “40-Wavelength Add-Drop Filter”, IEEE Photonics Technology Letters, November 1999 Vol. 11, p. 1437-1439). By setting the period of the flattening interferometer cascade-connected to the AWG to the same frequency as the channel spacing of the AWG, the top flatting of the channel band can be realized. FIG. 10A shows a coupler connecting part waveguide 103, an input side coupler connecting part waveguide 104, and waveguide arrays 105, and two waveguides extending from the coupler connecting part waveguide 103 are connected to output side waveguides 503, 504 of a Mach-Zehnder interferometer as a flattening interferometer as shown in FIG. 13.

The change of light output in the coupler connecting part waveguide 103 is as shown in FIG. 10B.

Further, when the channel spacing of the AWG is 100 GHz in signal frequency, for example, the flattening interferometer is designed so as to have a frequency of 100 GHz. Then, in the light intensity distribution at the output side of the AWG shown in FIG. 11A, light intensity mapping of the light output at the input side appears as shown in FIG. 11B, and the light intensity mapping has a focusing point horizontally moving according to the input optical wavelength because of wavelength diffraction effect by the waveguide array within the AWG. Then, it behaves as the light output constantly exists in the output optical waveguide. Accordingly, the optical power coupled to the output optical waveguide becomes constant and the channel band becomes a flat band (see FIG. 11C).

Note that FIG. 11A shows the waveguide arrays 105, an output side coupler connecting part waveguide 106, a coupler connecting part waveguide 103′, and an output side waveguide array 107, and FIG. 11B shows the change of light output in the coupler connecting part waveguide 103′.

FIGS. 12A and 12B show light intensity variations at the output side of a normal Gaussian AWG without such a flattening interferometer. In this case, since the focusing point moves along the frequency change, the band characteristic has a Gaussian shape.

FIG. 13 is a structural diagram of a conventional Mach-Zehnder interferometer. 501 denotes an input side waveguide, and 505, 506 denote optical multiplexer/demultiplexers. Further, 502 denotes a waveguide, and 503, 504 denote output side waveguides.

As described above using the flattening interferometer shown in FIG. 13, flattening of the AWG can be achieved while keeping the excessive loss of flattening small. However, in the flattening of the band using the conventionally used flattening interferometer shown in FIG. 13, the flat band is maintained only in the range of the period of the flattening interferometer to p of the period 2p, that is, only the half of the band moving according to the wavelength. Accordingly, the maximum value of the bandwidth with the loss of 30 dB is 50% in principle. Since the bandwidth on the order of 65% is often required when it is used for the application such as ROADM, broader bandwidth is required.

As below, disclosure examples of optical wavelength division multiplexer will be described.

In Japanese Laid-open patent publication NO. 2000-298222, in an optical circuit element in which first and second multiplexer/demultiplexers are connected with first and second waveguide, a third multiplexer/demultiplexer is inserted into the first waveguide, and a looped third waveguide is connected to the third multiplexer/demultiplexer, an optical wavelength division multiplexer formed using a multimode interference waveguide for the third multiplexer/demultiplexer is disclosed (See, Japanese Laid-open patent publication NO. 2000-298222).

In Japanese Laid-open patent publication No. 2004-199046, an optical wavelength division multiplexer having a phase generation function is disclosed (See, Japanese Laid-open patent publication No. 2004-199046). The optical wavelength division multiplexer disclosed in Japanese Laid-open patent publication No. 2004-199046 includes two two-input/two-output phase generation optical couplers, an optical length difference provision part formed by two optical waveguides sandwiched between these two two-input/two-output phase generation optical couplers, and respective two input/output optical waveguides connected to the phase generation couplers. The optical wavelength division multiplexer has a function of correcting the shift of wavelength spacing so that its drop characteristic may have a generally equal period on a wavelength axis, and the function is structured such that the phase difference between outputs of either or both of the phase generation optical couplers depends on the wavelength in the transmission band of the optical division multiplexer.

In Japanese Laid-open patent publication No. 7-082131, a stable optical ring filter hardly affected by outside thermal disturbance and having a double-resonator structure using two optical ring resonator waveguides is disclosed (See, Japanese Laid-open patent publication No. 7-082131).

### SUMMARY OF THE INVENTION

An object of the invention is to provide an optical wavelength division multiplexer capable of reducing excessive loss due to top flattening of band characteristic.

Another object of the invention is to provide an optical wavelength division multiplexer having a broad flat band of band characteristic.

As below, “SUMMARY OF THE INVENTION” will be described using numbers and signs used in “DETAILED DESCRIPTION OF THE INVENTION” with parentheses. The numbers and signs are added for making the correspondence between the description of “CLAIMS” and the description of “DETAILED DESCRIPTION OF THE INVENTION” clear, and they may not be used for interpretation of the technical scope of the invention described in “CLAIMS”.

According to the present invention, there is provided an optical wavelength division multiplexer including: a first coupler optical waveguide (104) and a second coupler optical waveguide (106); an input side connecting part waveguide (103) with one end connected to an input optical waveguide (101) and the other end connected to an optical input end face of the first coupler optical waveguide (104); an output side connecting part waveguide (103′) with one end connected to an output optical waveguide (107) and the other end connected to an optical output end face of the second coupler optical waveguide (106); an arrayed optical waveguide (105) connected between the first coupler optical waveguide (104) and the second coupler optical waveguide (106) and having plural channel waveguides with different lengths from one another.

The optical wavelength division multiplexer further includes an optical interferometer (102, 102′, 102″) connected to at least two optical waveguides at least either between the input side connecting part waveguide (103) and the input optical waveguide (101) or between the output side connecting part waveguide (103′) and the output optical waveguide (107).

The optical interferometer includes a ring structure (202, 302) that feeds back the input light, and is provided so that an interference period of the optical interferometer (102) may become equal to a difference between frequencies of light output from adjacent optical waveguides of the output side connecting part waveguide (107).

The ring structure according to a first embodiment of the present invention includes two or more ring resonators (202) serially connected between the two optical waveguides.

The optical interferometer (102′) according to second and third embodiments of the present invention has an asymmetric interferometer (303) and a ring resonator (302) is connected to the asymmetric interferometer (303). The ring resonator (302) feeds back light propagating through the asymmetric interferometer. An optical length of the ring resonator (302) is preferably a length twice an optical length of the asymmetric interferometer (303).

In the third embodiment of the invention, an optical waveguide at the output side relative to the optical interferometer (102′) is preferably one optical waveguide having a width equal to or more than twice a width of an optical waveguide at the input side.

According to the above configuration, flattening can be realized while reducing the excessive loss with the flattening of band characteristic in the arrayed waveguide grating by introducing the flat interference property of the ring resonator into the arrayed waveguide grating. Further, since the wavefront variations between modes are utilized, the flattening of band characteristic can be realized while maintaining the reduced size by high delta.

According to the optical wavelength division multiplexer of the invention, the flattening of band characteristic can be realized while reducing the excessive loss due to the flattening of band characteristic in the arrayed waveguide grating.

Further, the flattened band of the band characteristic can be made broader.

### BRIEF DESCRIPTION OF THE DRAWINGS

The above and other objects, advantages and features of the present invention will be more apparent from the following description taken in conjunction with the accompanying drawings, in which:

FIG. 1 is a Gaussian band characteristic diagram in a normal AWG.

FIGS. 2A to 2C are schematic diagrams showing maintenance of band constriction by a Gaussian AWG.

FIGS. 3A to 3C are schematic diagrams showing band characteristics is maintained by a flattening AWG.

FIG. 4 is an OADM configuration diagram using the flattening AWG.

FIG. 5 is a configuration diagram of an optical wavelength division multiplexer according to the invention.

FIG. 6 is a configuration diagram in the first embodiment of a flattening interferometer with ring resonator according to the invention.

FIG. 7 is a configuration diagram in the second embodiment of a flattening interferometer with ring resonator according to the invention.

FIG. 8 is a structural diagram of an output side tapered waveguide of the optical wavelength division multiplexer according to the invention.

FIGS. 9A to 9F are principle diagrams of light intensity distributions and band characteristics at a coupler coupling part.

FIGS. 10A and 10B are conceptual diagrams showing a principle of top flatting of the band characteristic at the input side of an AWG utilizing the flattening interferometer.

FIGS. 11A to 11C are conceptual diagrams showing a principle of top flatting of the band characteristic at the output side of an AWG utilizing the flattening interferometer.

FIGS. 12A and 12B are conceptual diagrams showing a principle of top flatting of the band characteristic at the output side of an AWG without the flattening interferometer.

FIG. 13 is a structural diagram of a conventional Mach-Zehnder interferometer.

FIG. 14 is a conceptual diagram showing the change of light intensity in the waveguide.

FIG. 15 is a band characteristic diagram in an arrayed waveguide grating according to the invention.

FIG. 16 is a configuration diagram in the third embodiment of a flattening interferometer with ring resonator according to the invention.

FIG. 17 is a band characteristic diagram for one channel in an arrayed waveguide grating according to the invention.

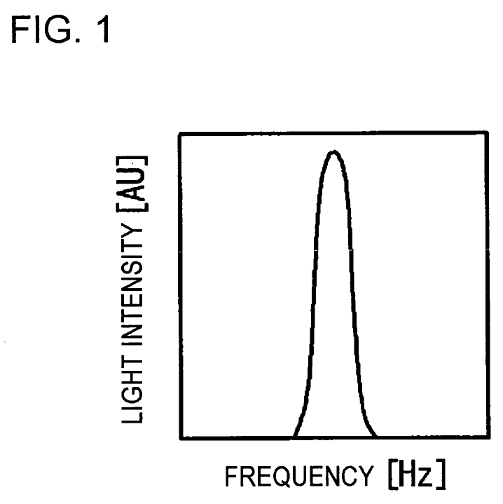

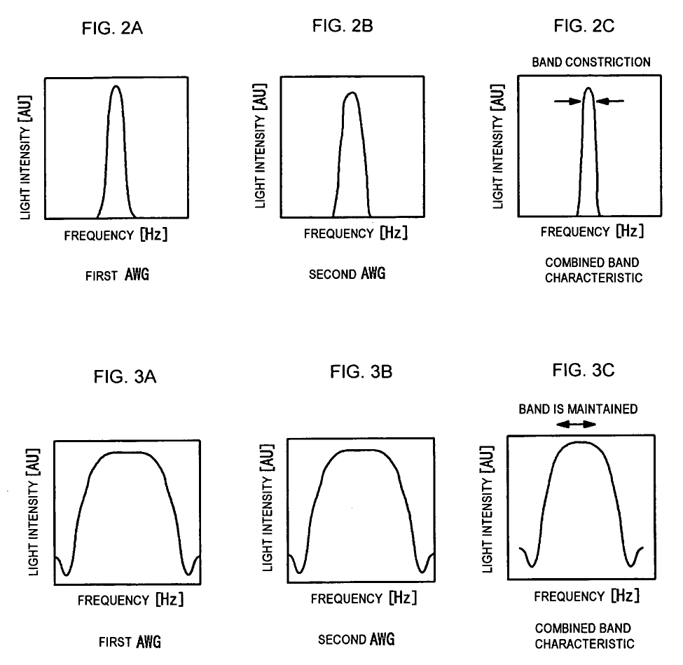

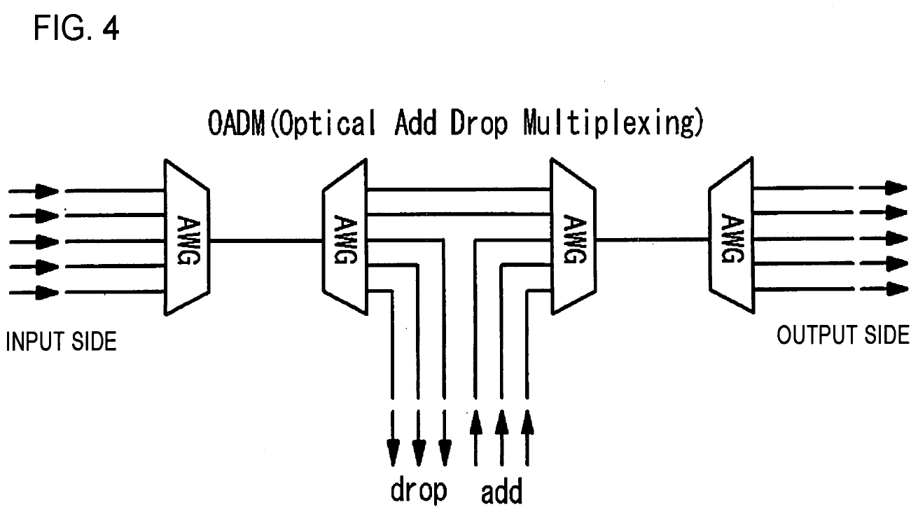

### DETAILED DESCRIPTION OF THE INVENTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Hereinafter, embodiments of an optical wavelength division multiplexer according to the invention will be described by referring to accompanying drawings. The invention is publicly used for an optical wavelength division multiplexer that can take only a desired channel in an wavelength division multiplexing (WDM) transmission system.

### First Embodiment

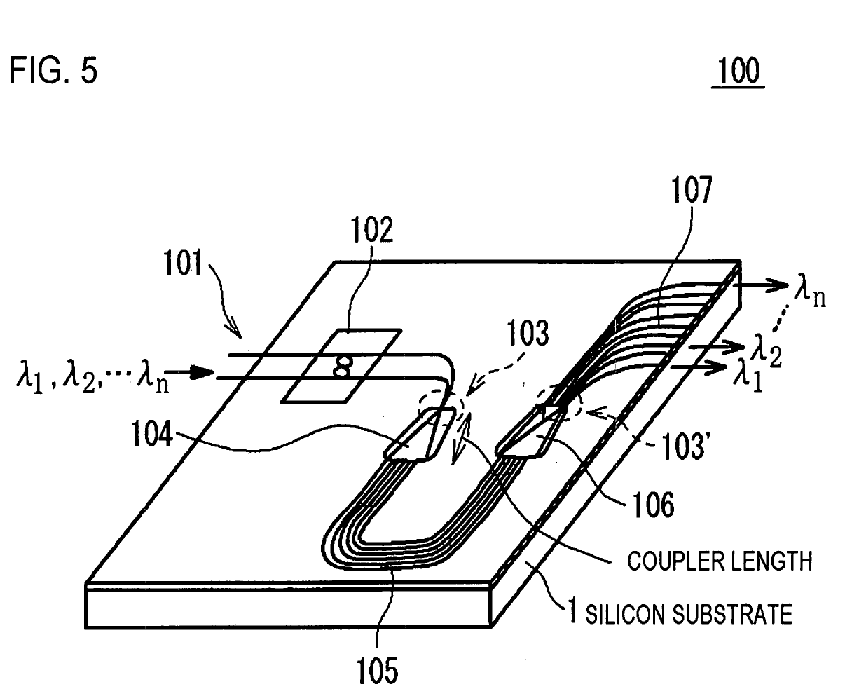

The first embodiment of the optical wavelength division multiplexer according to the invention will be described by referring to FIGS. 5, 6, and 8. FIG. 5 is a configuration diagram of the optical wavelength division multiplexer according to the invention. The optical wavelength division multiplexer according to the invention includes an arrayed waveguide grating 100, at least two input optical waveguides 101, and a flattening interferometer with ring resonator 102 containing a ring resonator. The flattening interferometer with ring resonator 102 is preferably cascade-connected to the arrayed waveguide grating 100. The arrayed waveguide grating 100 has a waveguide array 105 containing plural optical waveguides with different lengths and curvatures, an input side coupler optical waveguide 104 as a slab waveguide connected to the input side of the waveguide array 105, an output side coupler waveguide 106 as a slab waveguide connected to the output side of the waveguide array 105, and an output side waveguide array 107. The at least two input optical waveguides 101 are connected to the flattening interferometer with ring resonator 102, and connected to the input side coupler optical waveguide 104 via the coupler connecting part waveguide 103.

The output side waveguide array 107 is connected to the output side coupler waveguide 106 via a coupler connecting part waveguide 103′. Lights with wavelengths of λ1, λ2, . . . λn are input to the optical waveguides 101, respectively, and the respective lights with wavelengths of λ1, λ2, . . . , λn are output from the respective optical waveguides within the output side waveguide array 107. The input side coupler optical waveguide 104 has a coupler optical waveguide length of G.

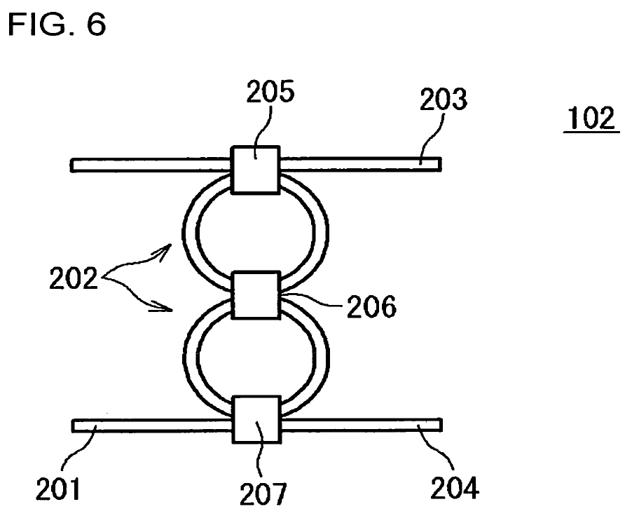

FIG. 6 is a configuration diagram of the flattening interferometer with ring resonator 102 in the embodiment. The flattening interferometer with ring resonator 102 includes an input optical waveguide 201 connected to the input optical waveguides 101, output optical waveguides 203 and 204 connected to the coupler connecting part waveguide 103, and a ring resonator 202. The ring resonator 202 has two ring-shaped optical waveguides connected to each other via an optical directional coupler 206. The input optical waveguide 201 is connected to the optical directional coupler 206 and the output optical waveguide 204 via an optical directional coupler 207. Further, the output optical waveguide 203 is connected to the ring resonator 201 via an optical directional coupler 205. By the configuration, the flattening interferometer with ring resonator 102 feeds back the light input to the input optical waveguide 201 by the ring resonator 202, and outputs the light from the output optical waveguides 203 and 204 to the input side coupler optical waveguide 104 of the arrayed waveguide grating 100. In this regard, the ring resonator 202 is provided so that the interference period frequency (grating frequency (Free Spectral Range)) of the flattening interferometer with ring resonator 102 may become equal to the difference between frequencies of light output from the adjacent optical waveguides in the output side waveguide array 107 (the channel spacing of the arrayed waveguide grating).

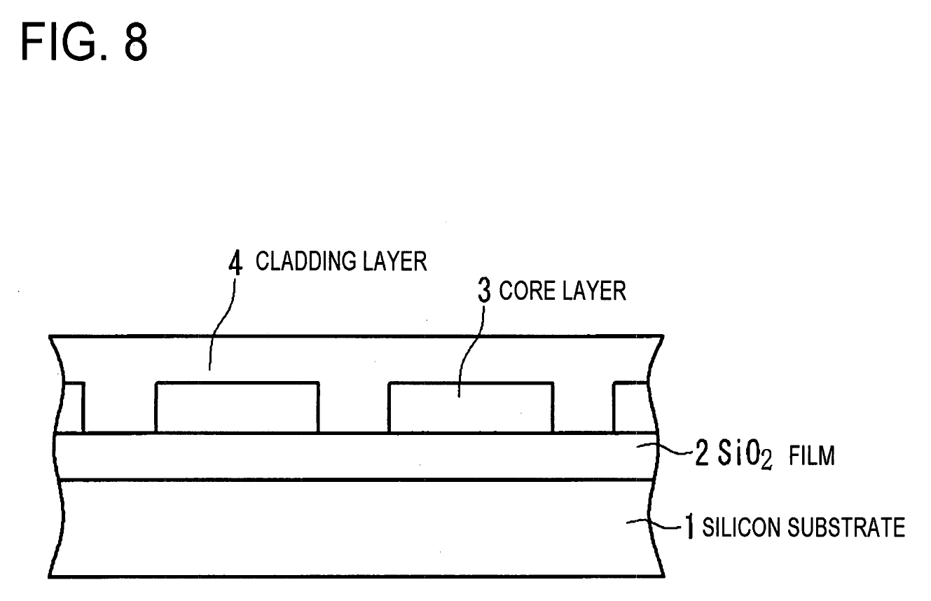

The optical wavelength division multiplexer according to the invention is formed on a silicon substrate. The optical waveguide formed on the silicon substrate is formed as a mode conversion waveguide. FIG. 8 is a partially cross-sectional view showing the section condition of the mode conversion waveguide. A core layer 3 forming the optical waveguide is formed by SiON on the SiO₂ film 2 formed on the silicon substrate 1, and covered by a cladding layer 4 formed on the SiO₂. This material selection realizes high relative refractive index difference Δ (=8% or more). The SiO₂ film 2, the core 3, and the cladding layer 4 can be fabricated using the flame deposition hydrolysis method (FDH method) or CVD method, for example. Accordingly, in order to achieve low cost and high performance of such a waveguide device, downsizing of the device is important. As a technique of downsizing, a technique of increasing the refractive index difference Δ (=n1−n2) between the core (refractive index n1) and the cladding (refractive index n2) of the waveguide is effective. The optical confinement in the waveguide can be made stronger when Δ is made larger, and thereby, the respective waveguide factors such as the minimum bend radius of the curved waveguide can be made smaller and the device size can be made smaller. For example, when an AWG is fabricated using a core material such as SiON that provides high refractive index difference from the SiO₂, the bend radius of the waveguide within the waveguide array 105 is made smaller on the order of the radius of curvature of 8 mm for refractive index difference of 0.5% to the radius of curvature of 0.2 mm for refractive index difference of Δ8%.

What is important as a parameter of the ring resonator 202 shown in FIG. 6 is a ring perimeter as a length around the ring resonator 202. The relationship between the ring perimeter and the channel period is expressed by the following equation.
L=c/(neff×FSR)
Where the channel period is FSR, the light speed is c, the effective diffractive index of glass is neff, and the operating wavelength is λ. In this case, when FSR is 100 GHz, neff=1.5 and λ=1.55 μm, and the ring perimeter is L=2 mm.

In order to equate the channel spacing at 100 GHz widely used in the AWG to the frequency, it is necessary to set the perimeter to 2 mm and set the bend radius of the waveguide within the waveguide array 105 to 300 μm. Further, since the bend radius can be made smaller, the size of the waveguide array 105 can be significantly made smaller, and thereby, the chip size of the waveguide within the waveguide array 105 can be reduced from ⅕ to 1/30. Since the yield from an 8-inch wafer can be increased from 20 to 30 utilizing the effect of the downsizing, it is important to realize not only the Gaussian but also the flat type AWG in the high Δ waveguide.

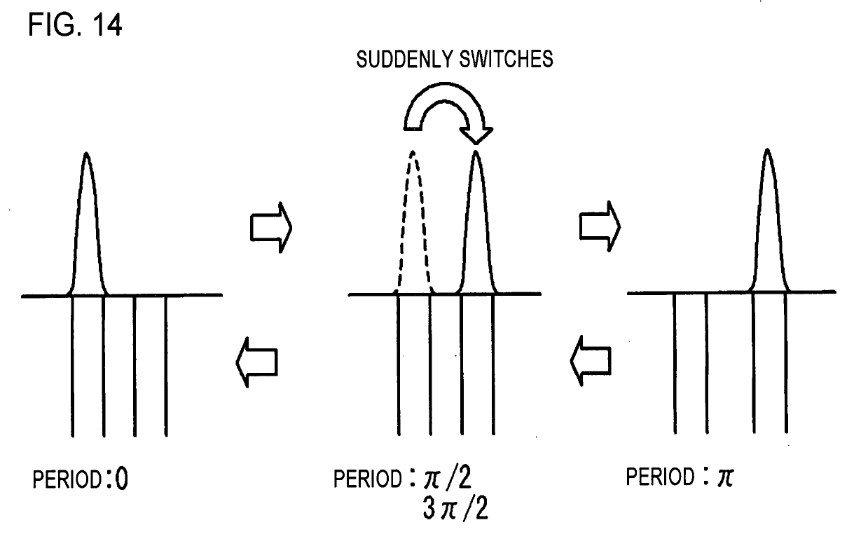

According to the optical wavelength division multiplexer of the embodiment, the change of light intensity in the coupler connecting part waveguide 103 suddenly switches at interference period of p/2 as shown in FIG. 14 because the optical wavelength division multiplexer has the flattening interferometer with ring resonator 102. Accordingly, although the central part of the channel is recessed (excessive loss is produced), the band characteristic of the arrayed waveguide grating 100 can expand the flat bandwidth. The flat bandwidth in the band characteristic of the arrayed waveguide grating 100 in the case of using such a structure is determined depending on the band characteristic of the flattening interferometer with ring resonator 102, and the flat bandwidth can be expanded to about 66% when the crosstalk to adjacent channels of 30 dB is ensured in the trade-off with the channel crosstalk.

### Second Embodiment

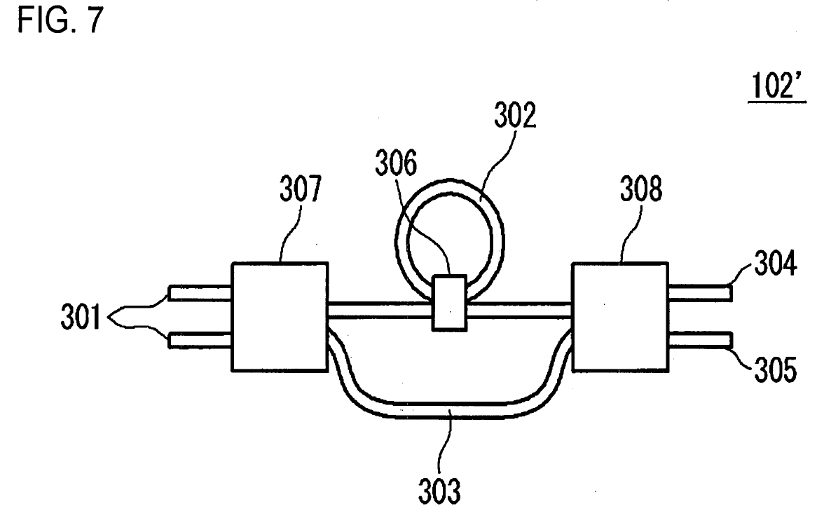

The second embodiment of the optical wavelength division multiplexer according to the invention will be described by referring to FIGS. 7, 14, and 15. The optical wavelength division multiplexer in the embodiment includes a flattening interferometer with ring resonator 102′ with Maximally flat filter structure in place of the flattening interferometer with ring resonator 102 in the first embodiment. As below, the same signs are attached to the same components as those in the first embodiment, and the description thereof will not be repeated.

FIG. 7 is a configuration diagram of the flattening interferometer with ring resonator 102′. Referring to FIG. 7, the flattening interferometer with ring resonator 102′ includes an input optical waveguide 301 connected to the input optical waveguides 101, output optical waveguides 304 and 305 connected to the coupler connecting part waveguide 103, a Mach-Zehnder interferometer 303, and a ring resonator 302. The ring resonator 302 is connected to the Mach-Zehnder interferometer 303 via an optical directional coupler 306.

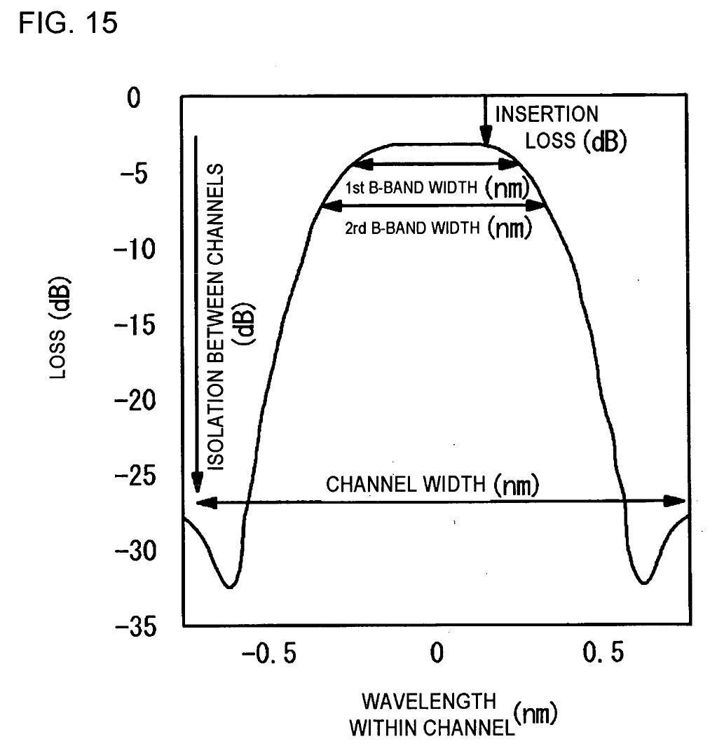

The input optical waveguide 301 is connected to the Mach-Zehnder interferometer 303 via an optical directional coupler 307. The output optical waveguides 304 and 305 are connected to the Mach-Zehnder interferometer 303 via an optical directional coupler 308. In this regard, the perimeter of the ring resonator 302 is provided to have a length twice the optical length difference of the Mach-Zehnder interferometer 303. For example, the optical length difference of the Mach-Zehnder interferometer 303 is set to 1 mm, the perimeter of the ring resonator 302 is set to 2 mm, and the coupling factor of the optical directional coupler 306 is set to 0.9. Then, the band characteristics of the output light in the two output optical waveguides of the output optical waveguides 304 and 305 are flattened to nearly 80% as shown in FIG. 15. Here, the band characteristic of the arrayed waveguide grating 100 is evaluated according to 1 dB bandwidth, 3 dB bandwidth, and the isolation from the adjacent channels as shown in FIG. 15. The 1 dB (3 dB) bandwidth is a bandwidth down to 1-dB (3 dB) lower from the light intensity at the band center, and the isolation is intensity crosstalk from the adjacent channels.

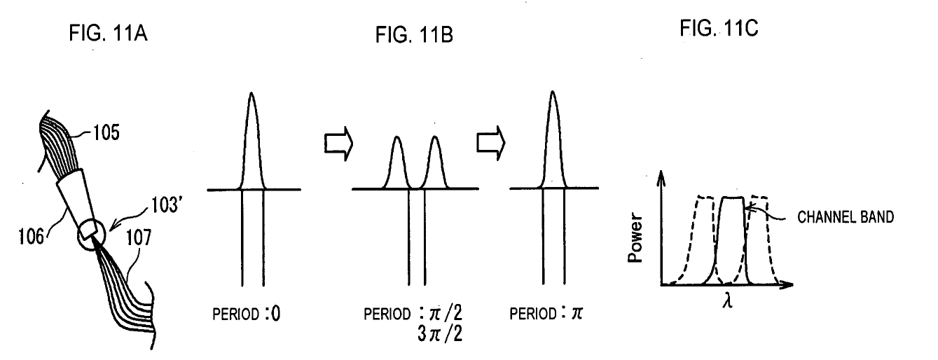

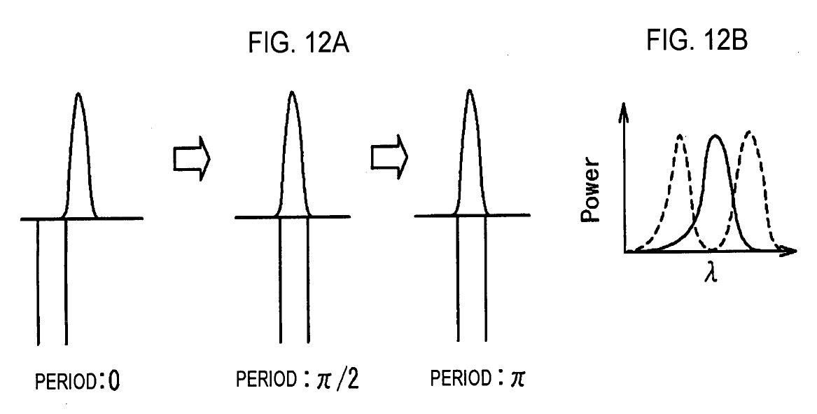

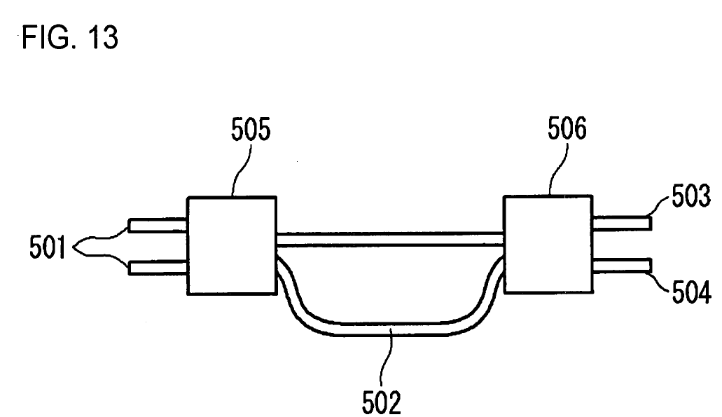

The fact that the flattening interferometer with ring resonator 102′ has a large flat band characteristic means that the change of light intensity in the two optical waveguides connected to the flattening interferometer with ring resonator 102′ suddenly switches at interferometer period of p/2 as shown in FIG. 14. Accordingly, although the central part of the channel is recessed (excessive loss is produced), the band characteristic of the arrayed waveguide grating 100 can expand the flat bandwidth. The flat bandwidth in the band characteristic of the arrayed waveguide grating 100′ in the case of using such a structure is determined depending on the band characteristic of the flattening interferometer with ring resonator 102′, and the flat bandwidth can be expanded to about 66% when the crosstalk to adjacent channels of 30 dB is ensured in the trade-off with the channel crosstalk. In order to ensure the adjacent crosstalk of equal to or more than 30 dB, it is necessary to maintain the status in which the peaks of the power coincide with the output center at phase 0 and phase p shown in FIG. 11B. Since the light intensity changes according to trigonometric function between phase 0 and phase p in the conventional interferometer structure, the transmission bandwidth is logically fixed to 50%. However, since the phase at which the optical power peak switches can be changed from 50% using the flattening interferometer, flattened band with a desired pass band can be realized. For example, when an interferometer with a period of 2p is designed so that the peaks may switch at phase 0 and phase p, the pass band becomes to 50%, and when the peaks switch at phase − 3/6p and phase 3/6p, the transmission band becomes 66%. In the flattening interferometer using a ring resonator, the band can be broadened to 66% because the band can be expanded from phase − 3/6p to phase 3/6p. Contrary, the band can be narrowed. The breadth of interference property of the flattening interferometer is structured to be equal to the flattened bandwidth.

As described above, the optical wavelength division multiplexer according to the invention can realize an AWG having a broader flat bandwidth of more than 50% utilizing a structure using the ring resonator for the flattening interferometer.

### Third Embodiment

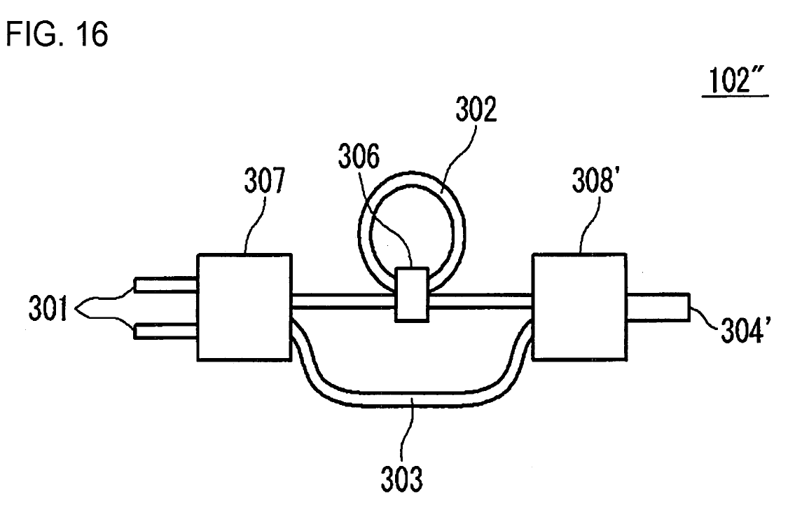

The third embodiment of the optical wavelength division multiplexer according to the invention will be described by referring to FIG. 16. The optical wavelength division multiplexer in the embodiment includes one output optical waveguide 304′ in place of the two output optical waveguides 304 and 305 connected to the Mach-Zehnder interferometer 303 in the second embodiment. In this regard, the output optical waveguide 304′ is connected to the Mach-Zehnder interferometer 303 via an optical directional coupler 308′. As below, the same signs are denoted to the same components as those in the first embodiment, and the description thereof will not be repeated.

The width of the optical waveguide in the embodiment has a width equal to or more than twice the optical waveguide width in the first and second embodiments, and the optical waveguide functions as a so-called multimode waveguide. The length of the interferometer in this case is expressed by the following equation.
L=(n+½)p/2(β0−β1)
Where β0 is a propagation constant of zero-order mode, and β1 is a propagation constant of first-order mode. Further, n is a number indicating the order of the bottom of the interference that periodically appears, and zero or a counting number.

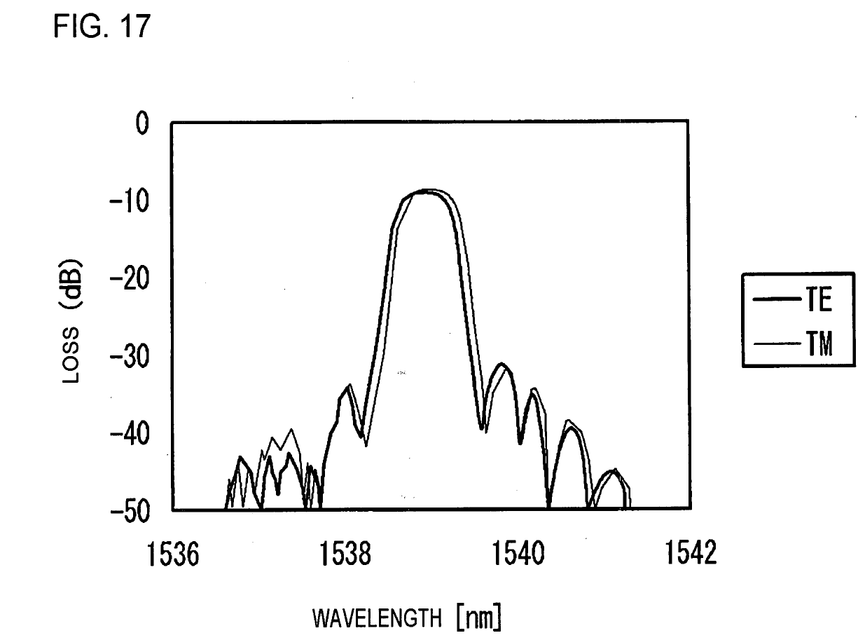

The optical wavelength division multiplexer according to the invention is realized, for example, by using SiON as a core material and depositing SiO₂ cladding on an Si substrate. For example, an SiO₂ film having a thickness of 0.1 μm is formed by the thermal oxidization method on a silicon substrate, and an SiO₂ film having a thickness of 1 μm is formed by the CVD method on the film. Subsequently, an SiON film having a thickness of 1 μm is deposited by the CVD method, patterned by the photolithography method so that the input and output optical waveguides to be connected to the coupler connecting part waveguide 103 or 103′ are formed to have a width of 2 μm, the coupler length G of 2 mm, and the minimum radius of curvature in the waveguide array 105 of 350 μm, respectively, and an SiO₂ film having a thickness of 1 μm to be a cladding layer is deposited thereon, and thus, a waveguide with Δ of 8% is formed. Referring to FIG. 17, the band characteristic for one channel of the band characteristic of an arrayed waveguide grating 100′ is shown.

By the way, the device using the optical wavelength division multiplexer according to the invention can be realized not only by the embedded waveguide of SiON of PLC (Planar Lightwave Circuit) but also by a compound semiconductor waveguide having a core of InGaAsP and a cladding of InP, or a glass waveguide structure having Ge-doped SiO₂ core and SiO₂ cladding.

The optical wavelength division multiplexer according to the invention can realize a desired flattened band using the effect of the wavelength filter having flat interference property formed using a ring resonator, while the flattened wavelength band with a transmission band of about 50% can be realized by the conventional interferometer structure. The band characteristic of the arrayed waveguide grating 100 is flattened. Further, flattening of band characteristic can be realized while maintaining the reduced size by high delta using the flattening interferometer. In the invention, in the case of the arrayed waveguide grating 100 having normal channel spacing of 100 GHz, 1 dB band becomes 66 GHz and 3 dB band becomes 80 dB.

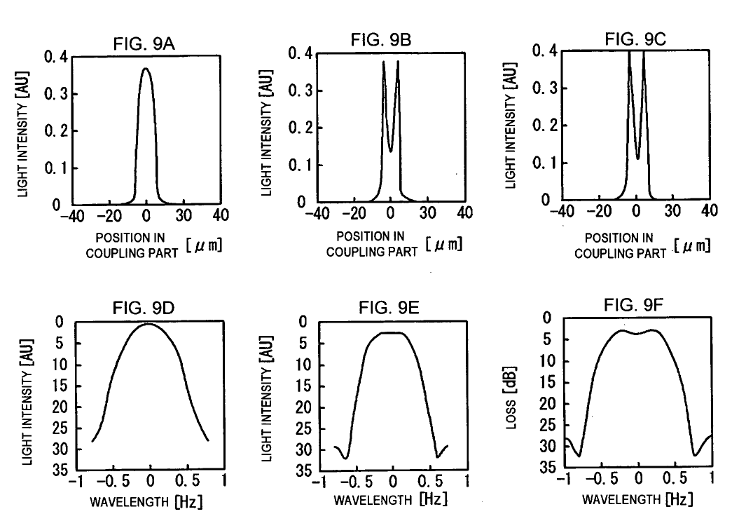

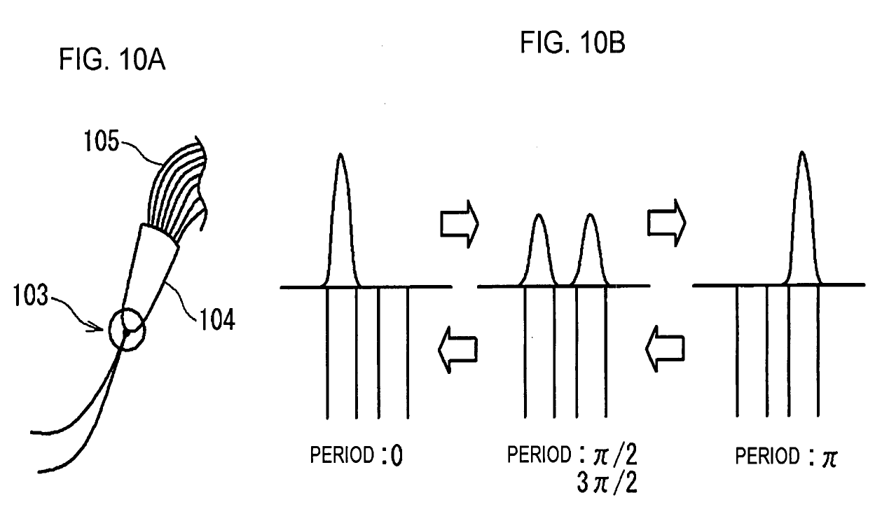

As above, the embodiments of the invention have been described in detail, however, specific configuration is not limited to the embodiments, and the invention includes changes in a range without departing the scope of the invention. By adding a change to the embodiment, the flattening interferometer with ring resonator 102 at the input side may be located at the output side. Alternatively, the flattening interferometer with ring resonator 102 may be provided at both the input side and the output side. In this case, since both input and output remain in the light intensity distributions in FIGS. 9B and 9E even when the frequency of incident light changes, the ratio of the flattened band within the band is further increased compared to the case using only one of them.

It is apparent that the present invention is not limited to the above embodiment, that may be modified and changed without departing from the scope and spirit of the invention.

What is claimed is:

1. An optical wavelength division multiplexer comprising:
a first coupler optical waveguides;
a second coupler optical waveguides;
an input side connecting part waveguide with one end connected to an input optical waveguide and the other end connected to an optical input end face of said first coupler optical waveguide;
an output side connecting part waveguide with one end connected to an output optical waveguide and the other end connected to an optical output end face of said second coupler optical waveguide;
an arrayed optical waveguide connected between said first coupler optical waveguide and said second coupler optical waveguide and having plural channel waveguides with different lengths from one another; and
an optical interferometer connected to at least two optical waveguides and provided at least either between said input side connecting part waveguide and said input optical waveguide or between said output side connecting part waveguide and said output optical waveguide,
wherein said optical interferometer includes a ring structure that feeds back an input light, and is provided so that an interference period of said optical interferometer may become equal to a difference between frequencies of light output from adjacent optical waveguides of said output side waveguide.

2. The optical wavelength division multiplexer according to claim 1,
wherein said ring structure includes two or more ring resonators serially connected between said two optical waveguides.

3. The optical wavelength division multiplexer according to claim 1,
wherein said optical interferometer has an asymmetric interferometer and a ring resonator is connected to said asymmetric interferometer, and
wherein said ring resonator feeds back light propagating through said asymmetric interferometer.

4. The optical wavelength division multiplexer according to claim 3,
wherein an optical length of said ring resonator is a length twice an optical length of the asymmetric interferometer.

5. The optical wavelength division multiplexer according to claim 3,
wherein an optical waveguide at the output side relative to said optical interferometer is one optical waveguide having twice a width equal to or more than a width of an optical waveguide at the input side.

6. The optical wavelength division multiplexer according to claims 1,
wherein said first and second coupler optical waveguides, said input side connecting part waveguide, said output side connecting part waveguide, said plural channel waveguides and interferometer are formed on a silicon substrate using SiON as a core material and SiO₂ as a cladding material.

7. The optical wavelength division multiplexer according to claim 1,
wherein said first and second coupler optical waveguides, said input side connecting part waveguide, said output side connecting part waveguide, said plural channel waveguides and interferometer are formed on an InP substrate using InGaAsP as a core material and InP as a cladding material.
